(19) United States
(12) Patent Application Publication
(10) Pub. No.: US 2011/0247542 A1
(43) Pub. Date: Oct. 13, 2011

(54) WATERCRAFT ACCESSORY

(76) Inventor: Patrick Xavier Jones, Nambour (AU)

(21) Appl. No.: 13/083,588

(22) Filed: Apr. 10, 2011

(30) Foreign Application Priority Data
Apr. 13, 2010 (AU) 2010201449

(51) Int. Cl. B63B 43/14; B23P 17/04; B63B 59/02; B63B 1/16; B63B 43/02; B63B 43/04

(52) U.S. Cl. 114/283; 114/360; 29/428

(57) ABSTRACT

The invention relates to an accessory for a watercraft, the watercraft including a body including a bow having an end, a stern and two sides, extending between the end of the bow and the stern, including gunwales at an upper edge. The accessory includes a body means adapted to lie substantially along the length of one side, substantially proximal to the gunwales. In use, two accessories are used, so that a body means lies substantially along the length of each side of the watercraft, and the body means are configured so as to provide increased flotation of the watercraft in the water. The invention also relates to an accessory for a watercraft which acts as a fender, reduces splash or spray, or increases lift of the watercraft as it moves through water. The invention also relates to a method of installing an accessory on a watercraft.

The present invention relates to an accessory for use with a watercraft.

Throughout the specification the meaning of the terms “bow”, “stern”, “gunwales”, “tender” and “fender” are intended to have their readily understood nautical meanings. For clarity, the term “bow” is intended to indicate the front point of a watercraft, “stern” the rear of a watercraft and “gunwales” the upper part of a watercraft. The term “tender” indicates a small boat, carried or towed by another watercraft, for use by the watercraft. The term “fender” is intended to mean something used to reduce contact, such as impact, rubbing or chaffing, of the outer parts of the watercraft with other objects, structures or watercraft. A “tinnie” is a small boat with an aluminium hull.

The following describes a non-limiting example of the invention being used with a small boat, such as a tinnie, that may be used as a tender. The watercraft accessory is applicable to many different forms of watercraft; it is not intended that the invention be limited to use with a small boat, tinnie or boat, or to a boat used as a tender.

The ubiquitous aluminium hulled tinnie is part of daily life by the water, as is evidenced by the number seen around beaches, harbours, rivers and marinas. There are also many other types of small boats made of wood, metal, plastic or fibreglass, for example. Most small boats are of a simple construction having seats and storage areas and powered by an outboard motor; some larger boats have a shade or cabin installed. All of these small boats work hard for their owners, taking them fishing, transporting people from “A to B”, to and from islands, to favourite beaches or to snorkelling spots etcetera. Some small boats are used as tenders to attend to another watercraft such as to transport people and their gear to and from a yacht.

Known small boats or tinnies can be somewhat unstable, and do not have good flotation properties. Some flotation may be provided by foam or polystyrene stored in the floor or compartments of the boat. Nevertheless, if these known boats take on lots of water there is usually insufficient flotation to keep the people and gear inside afloat. The boat may capsize if tilted too far to one side, such as if a person tries to get in the boat from the water. Once capsized it is extremely difficult to right the boat and it may sink. Small boats are often used as life-rafts or rescue boats so it is imperative that these boats have good flotation properties, for safety.

Inflatable dinghies made of rubber have greater flotation and stability than classic tinnies and other small boats. However, dinghies are expensive to buy, require inflation, and frequent maintenance to keep them functional. It is highly desirable to have increased flotation in a small boat, without the expense or problems of a dinghy.

When small boats or tenders are tied up to structures or other watercraft there may be contact between the side of the boat and the structures or other watercraft. The contact may be an impact, in high winds or seas, or an accidental crash, or may be rubbing or chaffing together of two surfaces over time. Other objects in the water, such as buoys or floating debris may also contact the side of the boat, potentially causing damage. To try to avert damage fenders are used; these may be knots of rope or other material hung over the side of the boat. These fenders are soft but do not effectively deflect hard objects, structures or watercraft that may contact the boat. Hard plastic teardrop shaped fenders are also known, several being hung over the side of a boat to deflect direct contact between the boat and other objects, structures or watercraft. Since these fenders are made of a hard material themselves, these fenders may also rub or chaff the surfaces of the boat and another watercraft, for example, which is undesirable. Further if an object, structure or watercraft impacts these hard fenders, the fender itself may cause considerable damage to the side of the boat. If a boat itself is made of a softer material, such as an inflatable dinghy the material is still sufficiently hard to scuff or damage the surface or paintwork of another watercraft, for example. It is desirable therefore to have an improved fender that better protects a boat from objects, structures or watercraft and will not itself damage the surface of the boat or another watercraft, for example.

As a boat moves through water it is desirable for the boat to generate lift. Small boats generally do not generate sufficient lift as they travel and the bow may dip into waves leading to water being taken on-board. It is also usual for there to be a significant amount of water splashed and sprayed in to the boat. The splash and spray may make the journey uncomfortable for the passengers and may damage items they have brought with them, such as a digital camera. If lots of water comes into the boat the flotation of the boat may be compromised, leading to capsize or sinking of the boat, as discussed above. More expensive watercraft have specially designed hull shapes to assist the lift of the boat, and in particular the bow of the boat. The hull shape may also reduce to some extent the splash or spray of water in to the boat. It is highly desirable to be able to generate increased lift and or reduced splash or spray for a small boat as it moves through water, in a convenient and inexpensive manner.

For clarity, any prior art referred to herein, does not constitute an admission that the prior art forms part of the common general knowledge in Australia or elsewhere.

It is an object of the present invention to provide an accessory for a watercraft that at least ameliorates one or more of the aforementioned problems of the prior art.

Accordingly, in a first aspect, the present invention provides an accessory for a watercraft, the watercraft including a body including a bow having an end, a stern, and two sides, extending between the end of the bow and the stern, and including gunwales at an upper edge, and the accessory including
a body means, adapted to lie substantially along at least part of the length of one side, substantially proximal to the gunwales, and
an attachment means for attaching the body means to the watercraft,
   wherein, in use, two accessories are used, attached to the watercraft by the attachment means so that a body means lies substantially along at least part of the length of each side of the watercraft, and the body means are configured so as to provide increased flotation of the watercraft, in the water.

Preferably, the flotation provided by the body means is sufficient to substantially prevent the watercraft sinking due to taking on water. Preferably, if the watercraft is tilted over to one side in the water, the body means attached to the tilted side contacts water, and the body means has sufficient flotation to substantially act against the tilting.

According to the present invention, in a second aspect, there is provided an accessory for a watercraft, the watercraft including a body including a bow having an end, a stern, and two sides, extending between the end of the bow and the stern, and including gunwales at an upper edge, and the accessory including
a body means, adapted to lie substantially along at least part of the length of one side, substantially proximal to the gunwales, and
an attachment means for attaching the body means to the watercraft,
   wherein, in use, the accessory is attached to the watercraft by the attachment means, and the body means acts as a fender, substantially preventing contact between the watercraft and objects, structures or other watercraft which otherwise would contact the watercraft at or near where the accessory is attached.

With respect to the second aspect, preferably, in use, two accessories are used, attached to the watercraft by the attachment means so that a body means lies substantially along at least part of each side of the watercraft.

In a third aspect, the present invention provides, an accessory for a watercraft, the watercraft including a body including a bow having an end, a stern and two sides, extending between the end of the bow and the stern, and including gunwales at an upper edge, and the accessory including
a body means, adapted to lie substantially along at least part of the length of one side, substantially proximal to the gunwales, and
an attachment means for attaching the body means to the watercraft,
   wherein, in use, two accessories are used, attached to the watercraft by the attachment means so that a body means lies substantially along at least part of the length of each side of the watercraft, and the body means are configured so as to substantially increase the lift of the watercraft as the watercraft moves through water.

With respect to the third aspect, preferably, in use, as the watercraft moves through water the configuration of the body means substantially increases the lift of the bow of the watercraft.

In a fourth aspect, the present invention provides, an accessory for a watercraft, the watercraft including a body including a bow having an end, a stern and two sides, extending between the end of the bow and the stern, and including gunwales at an upper edge, and the accessory including
a body means, adapted to lie substantially along at least part of the length of one side, substantially proximal to the gunwales, and
attachment means for attaching the body means to the watercraft,
   wherein, in use, two accessories are used, attached to the watercraft by the attachment means so that a body means lies substantially along at least part of the length of each side of the watercraft, and the body means are configured so as to substantially reduce splash or spray of water in to the watercraft as the watercraft moves through water.

With respect to the fourth aspect, preferably, the body means is shaped to direct splash or spray of water away from the watercraft as the watercraft moves through water.

Each of the four aspects of the invention may be combined with one or more of the other aspects of the invention. In one form of the invention, preferably, the accessory includes all four aspects.

In the various aspects of the invention described above, the watercraft may be a boat, tinnie or other small watercraft, used as a tender.

Preferably, the body means is attached somewhere between the chine line and the upper edge of the gunwales.

Preferably, the body means is attached high up on the side of the watercraft, close under the gunwales.

Preferably, the body means floats in water.

The body means may be made of any suitably soft material such that objects, structures or watercraft in contact with the body means will not be substantially damaged by the contact. Preferably, the body means is made of a suitable foam material; the suitable foam may be a polyolefin foam.

The body means may be constructed of a plurality of layers of material attached or held together.

In a preferred form of the invention, the body means includes an inner face which in use lies on a side of the watercraft, and an outer face, opposite the inner face, and furthest from the side of the watercraft, with a top face above and between the inner and outer faces and a lower face below and between the inner and outer faces, and two end faces, each surrounded by the inner, outer, top and lower faces, and when the body means is attached to a side of the watercraft one end face is closer to the bow of the watercraft than the other end face. The outer face may have a substantially flat surface and the substantially flat surface may assist to diffuse the force of an impact by objects, structures or other watercraft on the body means.

Preferably, the outer face and or the end face closer to the bow of the body means is configured to be at an angle to the vertical suitable to substantially increase lift of the watercraft as the outer face and or the end face closer to the bow strikes water, as the watercraft moves through water.

Preferably, the outer face and or the end closer to the bow is configured to be at an angle to the vertical suitable to direct splash or spray of water away from the watercraft, as the outer face and or the end face closer to the bow strikes water, as the watercraft travels through water.

The accessory closer to the end of the bow may be at an angle to the vertical similar to the angle to the vertical of the front of the watercraft.

Preferably, the inner face is adapted to have an angle to the vertical substantially similar to that of the side of the watercraft so, in use, the inner face of the body means lies flush with the side of the watercraft and the outer face is configured to be at a substantially similar angle to the inner face. The body means may be substantially a parallelogram in cross-section.

In one form of the invention the body means may include one or more substantially curved faces or edges to a face.

In a preferred form of the invention, the body means is adapted to be attached from the end of the bow substantially along the entire length of a side of the watercraft. Two body means may be attached and the body means adapted to fit closely around the bow of the watercraft.

The attachment means may include gluing the body means to the side of the watercraft to which the body means is to be attached by application of a suitable adhesive to the body means and or the side of the watercraft.

Preferably, the attachment means includes a plurality of fixing means corresponding to attachment points on the watercraft. The fixing means may include any one or more of nuts and bolts, clamps, nails, pins, screws and ties, or any other suitable fixing means, or any combination thereof. The fixing means may be made of any suitable strong material such as metal including stainless steel, or plastic, including nylon, or any combination thereof.

Preferably, the body means includes one or more recess means open to an outer face of the body means, the or each recess means being adapted to receive at least part of a fixing means therethrough during attachment, and the recess means being configured so that once the body means is attached on a side of the watercraft the fixing means does not substantially project beyond the outer face of the body means.

Preferably, the attachment means includes one or more plate means, adapted to lie on an outer face of the body means. The plates means may be made of any suitable material such as wood, metal including aluminium, or plastic including nylon, or any combination thereof.

Most preferably, the body means includes one or more recess means and the attachment means includes one or more plate means, corresponding to the recess means, and the plate means are adapted to be positioned one in the or each recess means, and the fixing means is passed through both the recess means and the plate means to attach the body means to the watercraft.

Preferably, the fixing means are a plurality of bolts, or the like, passed through the recess means, plate means and the body means, and the attachment points on the watercraft include an aperture and each bolt, or the like, passes through the aperture in the watercraft, or each bolt, or the like, is passed through the aperture in the watercraft first, then the body means, recess means and plate means, and plurality of corresponding nuts, or the like, is applied one each to the end of each bolt, or the like, and tightened to attach the body means to the watercraft. Optionally, the attachment means includes one or more washers.

The accessory may be adapted to enable safety equipment, or similar, to be attached, such as in an emergency situation.

In an alternative form of the invention the body means may be constructed of a plurality of separate parts attached by the attachment means along a side of the watercraft. In another alternative form of the invention a single body means may be used, adapted to lie substantially along at least part of the length of each side of the watercraft. In a further alternate form of the invention the body means may be manufactured integral to the watercraft.

The invention provides in one form of the invention, an accessory for a watercraft, the watercraft including a body including a bow having an end, a stern, and two sides, extending between the end of the bow and the stern, and including gunwales at an upper edge, and the accessory including
a body means, adapted to lie substantially along at least part of the length of one side, substantially proximal to the gunwales, and
an attachment means for attaching the body means to the watercraft,
   wherein, in use, two accessories are used, attached to the watercraft by the attachment means so that a body means lies substantially along at least part of the length of each side of the watercraft, and the body means are also configured so as to substantially increase the lift of the watercraft as the watercraft moves through water.

Preferably, in this form of the invention the body means is also shaped to direct splash or spray of water away from the watercraft as the watercraft moves through water.

Preferably, in use, the body means also acts as a fender, substantially preventing contact between the watercraft and objects, structures or other watercraft which otherwise would contact the watercraft at or near where the accessory is attached.

The invention also provides a method of installing an accessory on a watercraft, the watercraft including a body including a bow having an end, a stern and two sides extending between the end of the bow and the stern, and including gunwales at an upper edge, the method including the following steps:

i) cutting a body means from a piece of suitable material to fit substantially along at least part of the length of one side of the watercraft, substantially proximal to the gunwales;

ii) shaping the body means so as to be able to lie substantially flush with the side of the watercraft and to be substantially a parallelogram shape in cross-section; and

iii) attaching the body means to the side of the watercraft by attachment means.

Preferably, the method includes one or more of the following further steps:

iv) marking and making one or more recesses means in the body means for receipt of the attachment means therethrough.

v) positioning plate means in the or each recess means before attaching the body means to the watercraft.

vi) applying adhesive to the body means and or the side of the watercraft before attaching the body means.

Preferably, the attachment means includes a plurality of nuts and bolts, or the like, each bolt, or the like, passing through the plate means, the recess means, the body means and an aperture in the side of the watercraft corresponding to the position of the recess means, or in reverse order, and tightened by a corresponding nut, or the like, on the end of each bolt, or the like, to attach the body means to the side of the watercraft.

Preferably, the suitable material is foam. In a preferred form of the invention, the body means is adapted to be attached from the end of the bow substantially along the entire length of a side of the watercraft.

The invention will now be described in connection with a non-limiting preferred embodiment with reference to the accompanying drawings, in which:

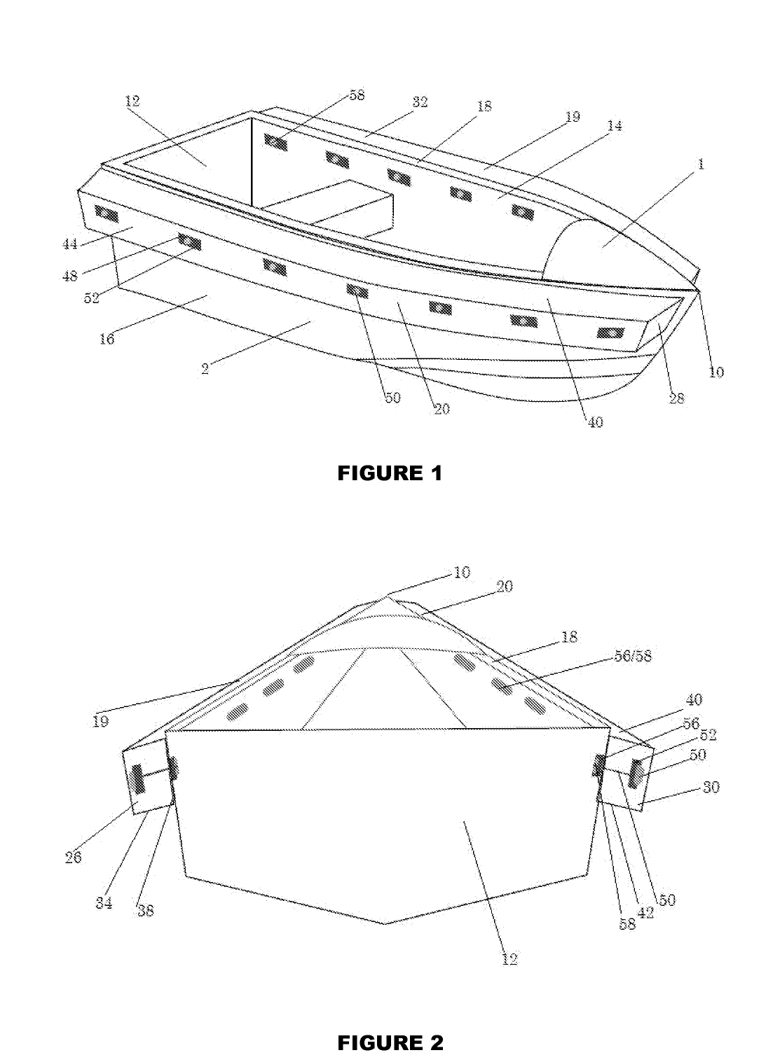

FIG. 1 is a perspective view from above of a pair of watercraft accessories according to a preferred embodiment of the invention, attached to a small boat;

FIG. 2 is a rear view of the accessories and boat of FIG. 1;

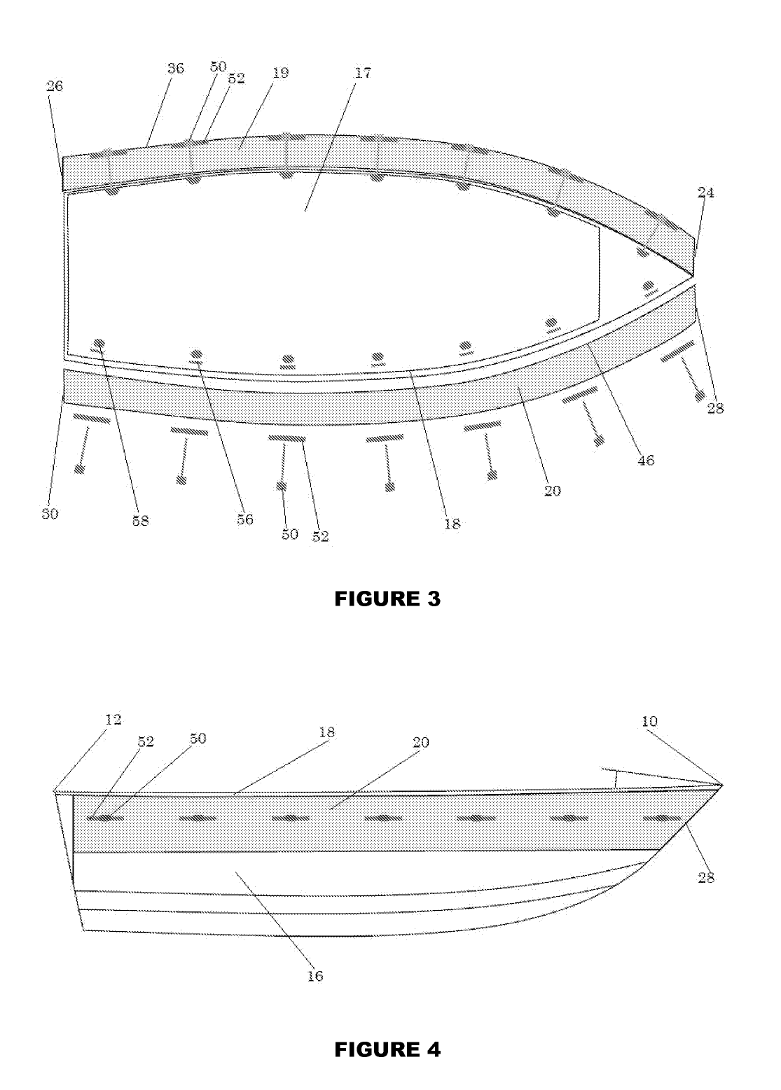

FIG. 3 is a plan view from above of the accessories and boat of FIGS. 1 and 2, with one accessory and corresponding attachments shown in exploded view; and

FIG. 4 is side view of the accessories and boat of FIGS. 1 and 2.

Referring to FIGS. 1 to 4, the invention will now be described attached to boat 1. Boat 1 is a small boat or tinnie, the invention is, however, applicable to many different types of watercraft, including multi-hull or larger vessels. Boat 1 has a body 2, including a bow 10, the front point of boat 1, and a stern 12, the rear part of boat 1. Body 2 also includes sides 14 and 16 extending between bow 10 and stern 12 surrounding floor 17 (refer FIG. 3). Body 2 of boat 1 has gunwales 18, at an upper part of sides 14 and 16, bow 10 and stern 12.

Accessory bodies 19 and 20 are attached along the length of the sides 14 and 16, respectively, between bow 10 and stern 12, and close to gunwales 18. Accessory body 19 or 20 are preferably positioned between the chine line and the upper part of the gunwales 18 of boat 1 to be most useful as a fender, flotation device, creating lift and for deflecting splash and spray away from the occupants of boat 1. In one form of the invention, where the invention is used exclusively as a fender, a single accessory body 19 or 20 may be used attached to either side 14 or 16, where the risk of damage is from only one side. In an alternative form of the invention, accessory bodies 19 and 20 may be adapted to lie along only some of the length of the sides 14 and 16, as appropriate. In another alternative form of the invention a single accessory is used adapted to lie along both sides of the boat, and around the bow 10.

Accessory bodies 19 and 20, as illustrated, are made of a closed cell, polyolefin foam, but any suitable foam or other suitable material could be used. Closed cell polyolefin foam is particularly suitable as the closed cell structure allows the material to provide significant flotation in water. Further, the material is water resistant to 3% volume after 28 days, is UV resistant and has a wide operating temperature range of −40° C.+95° C. . Polyolefin foam is available in a range of grades from soft to rigid enabling a suitable softness to be selected. The accessory bodies 19 and 20 need to be made of a suitable grade of foam that is soft enough not to cause damage to boat 1 or other objects, structures or watercraft it may contact. The grade of foam must also be strong enough to withstand forces of water, not to break up in use and to act as a fender to deflect objects. A foam density of 25 kg/m³ is particularly suitable. Use of foam for accessory bodies 19 and 20 is beneficial as foam is inexpensive, light to transport and easy to handle when attaching to boat 1. The foam may be treated to be flame resistant, or may include a protective coating against the action of prolonged exposure to seawater or spray and any microorganisms contained therein. Use of a particular colour of foam could be used for identification purposes. In an alternative embodiment the accessory bodies 19 and 20 may be constructed of fibreglass, metal, wood or plastic or any combination thereof, configured to be hollow or otherwise float in water, perhaps with a soft material cover.

Each accessory body 19 or 20 as illustrated is a long strip of material, which bends to be fitted around curved sides 14 and 16. Typically the length of accessory body 19 or 20 will be around 3 to 3.5 meters long and will weigh around 10 kg. Although not illustrated, many layers of foam are used, glued together to create a suitable strip for shaping in to accessory body 19 or 20. Each accessory body 19 or 20 has a pair of ends 24 and 26, and 28 and 30, respectively, where ends 24 and 28 are attached at or close to bow 10 and ends 26 and 30 are attached at or close to the ends of sides 14, 16 close to stern 12. Ends 26 and 30 are cut to be approximately vertical as illustrated. Ends 24 and 28, in the described preferred embodiment are cut at an angle to the vertical similar to that of the front of the boat 1 to facilitate lift of the bow 10 as boat 1 moves through water. Further the angle to the vertical of ends 24 and 28 assists to direct splash and spray of water away from the boat 1. Alternatively, ends 24, 26, 28 or 30 may have any suitable angle.

Accessory body 19 has four faces, an upper face 32, a lower face 34, an outer face 36, and an inner face 38, and correspondingly accessory body 20 has an upper face 40, a lower face 42, an outer face 44, and an inner face 46. As illustrated inner faces 38 and 46 of accessory bodies 19 and 20 are at an angle to the vertical very similar to the angle to the vertical of the side 14 or 16, so as to lie flush thereon when attached. Outer faces 36 and 44 are at the same or similar angle to the vertical as the inner faces 38 and 46 so that the accessory bodies 19 and 20 are substantially a parallelogram in cross-section. The cross-sectional shape may also be described in the art as an “off-set rectangle”. In use, accessory bodies 19 and 20 are shaped to fit closely along sides 14 and 16 of boat 1, close to bow 10 and to attach at the stern 12 end of sides 14 and 16. In alternative embodiments other shapes of accessory bodies 19 and 20 are envisaged, such a parallelepiped, or a cylinder. Other alternative embodiments of accessory bodies 19 and 20 include being rectangular (including square), circular or irregular in cross-section. The accessory bodies 19 and 20 may, in another alternative form of the invention be formed of a number of separate parts attached along the sides 14 and 16 of boat 1.

The angle to the vertical of outer faces 36 and 44 is beneficial to increase the lift of the boat 1 as it moves through water. As accessory bodies 19 and 20 are attached closely around bow 10 there is more accessory body around bow 10 relative to the rest of the boat 1, and therefore greater lift is produced at the bow of boat 1 compared to the rest of boat 1. The angle to the vertical of outer faces 36 or 44 is also beneficial to direct splash or spray of water away from the boat 1 as the boat 1 moves through water. Since the accessory bodies 19 and 20 are also positioned high up under the gunwales 18 the benefits of the angle are optimised to increase lift, act as an effective fender, direct spray and splash away from the boat 1 and importantly to the effective flotation properties of the accessory bodies 19 and 20. Alternative positions of accessory bodies 19 and 20 may be used such as lying closer to the chine line.

Outer faces 36 and 44 have a flat surface in the described embodiment, which assists to deflect objects, structures or watercraft that might otherwise collide or contact the watercraft, and diffuse the force of the impact through the accessory body 19 or 20 rather than boat 1. In an alternative embodiment it is envisaged that the outer faces 36 and 44 could be textured, ribbed or rounded or otherwise configured. Any one or more of faces 32, 34, 36, 38, 40, 42, 44 and 46 in an alternative embodiment could be curved or have curved edges (not labelled) to facilitate deflection of other objects, structures or watercraft that may contact the accessory body 19 or 20.

Referring in particular to FIG. 3, outer faces 36 and 44 have recesses 48 spaced along their length, 7 in the illustrated embodiment. More or less recesses 48 could be used as appropriate to the length and or size of boat 1, or a single recess 48 could be used running along some of the length of accessory bodies 19 and 20. As illustrated, each recess 48 is adapted to receive a bolt 50 which passes through a plate 52, glued inside recess 48, and hole 54 (not shown) in boat 1, and finally through washer 56. (Refer FIG. 2 where 56/58 represents the position for the holes in boat 1 and washer 56 and nut 58). Nuts 58 are tightened on bolts 50 against washers 56 from inside of boat 1. Bolts 50 are therefore tightened against plates 52 so as to hold accessory body 19 or 20 tightly in place, flush with the side 14 or 16, high up against the gunwales 18. Holes may be made in accessory body 19 or 20 from outer faces 36 or 44 through each recess 48 through to inner faces 38 or 46 for receipt of bolt 50 or bolt 50 may be drilled or screwed straight through accessory body 19 or 20. Readily, bolt 50 could be passed through washer 56 and hole 54 (not shown) in boat 1 first, then through the accessory body 19 or 20, into recess 48 through plate 52 and the nut 58 tightened in recess 48. Plates 52 diffuse through the rest of the accessory body 19 or 20 the tightening force of the nut 58 on bolt 50, so as to reduce strain on the areas of attachment.

Although the preferred embodiment is described with reference to a “nut and bolt” arrangement, any suitable fixing means may be used to attach the accessory bodies 19 and 20 to side 14 or 16 for example, clamps, nails, pins, screws and or ties or any combination thereof. Holes 54 (not shown) in boat 1 could, in alternative embodiments, be readily replaced with other attachment points, such as several steel loops attached to the side of boat 1.

As illustrated nuts 58, bolts 50 and washers 56 are made of stainless steel but other metals or plastic such as nylon could also be used, or any combination of suitable materials. Plates 52 as shown are made of nylon but other suitable materials include stainless steel, aluminium, other metals, wood or plastic, or any combinations thereof. Washer 56 and plates 52 are beneficial but one or both may be omitted in an alternative embodiment of the invention. Bolt 50 and plate 52 are seated within recess 48 so that no part of the bolt 50 or plate 52 extends beyond outer face 36 or 44. In this way the bolt 50 does not contact other objects, structures or watercraft that might contact accessory body 19 or 20. Rubbing, chaffing or scratching of paint of other watercraft or structures by bolt 50, or other parts of the means of attaching accessory body 19 or 20 to the boat 1, is therefore prevented.

The method of installation of accessory bodies 19 or 20 is to glue layers of foam together and once dry, cut to form a length of the foam strip appropriate to fit around from the bow 10, along sides 14 and 16, to the stern 12 end of sides 14 and 16 of the boat 1. The foam is cut or shaped, by hand or using a band saw or the like, to have a parallelogram or “off-set rectangle” cross-section, suitable to lie flush with the side 14 or 16 of the boat. The positions of recesses 48 are marked on accessory body 19 or 20 corresponding to holes 54 (not shown) in side 14 or 16 of boat 1. Accessory body 19 or 20 is further shaped to fit boat 1, having ends 24 and 28 cut to an angle to the vertical similar to the angle to the vertical of the front of the boat. A template may be used or created at this stage of installation which can then be used to install further accessory bodies 19 and 20. Recesses 48 are cut out, again by hand or otherwise and plates 52 glued into each recess 48, and allowed to dry. Adhesive is used between side 14 and accessory body 19 or 20 as nuts 58, bolts 50 and washers 56 are applied to attach accessory body 19 or 20 tightly up against gunwales 18 and flush with side 14 or 16 of boat 1, as described above. Any suitable adhesives may be used throughout. The process is then repeated for the other side of boat 1 and the other accessory body 19 or 20. The particular size and shape of the accessory bodies 19 and 20 will be different depending on the size and particular kind, or type of boat 1 to which the accessories are to be attached. Although in the described embodiment the accessory bodies 19 and 20 are cut to shape to fit to the boat 1, they could equally be preformed, or manufactured in suitable sizes to fit most boats 1 or alternatively in specific sizes for specific kinds of boat 1. Alternatively, the accessory bodies 19 and 20 could be manufactured integral to the boat 1. It is envisaged that accessory bodies 19 and 20 could be used on the outer sides of a catamaran or other multi-hull watercraft or four accessory bodies could be used on either side of each float.

Safety equipment or other gear may be attached to accessory body 19 or 20, in use, or in an emergency situation to assist rescue.

The illustrated embodiment of accessory bodies 19 and 20 provides increased flotation sufficient to prevent boat 1, in typical circumstances from sinking even if it has taken on water. The flotation acts to reduce the risk of capsizing, or in the event of capsizing allows boat 1 to be readily righted. The flotation provided by accessory bodies 19 and 20 is intended also to act against tilting of boat 1, such as when a person tries to climb over side 14 or 16 to get in boat 1, from the water. The position of accessory bodies 19 and 20 high under the gunwales 18, above the chine line, is particularly important in maintaining the successful flotation of boat 1. The position high under gunwales 18 is also helpful as having accessory bodies 19 and 20 in this position is most effective as a fender to deflect contact of objects, structures or watercraft, from sides 14 or 16. As a fender the soft material used is beneficial as it will not rub, chaff or otherwise damage the paintwork of other watercraft, or boat 1 itself, if used as a tender, for example. Any impact, such as from a marina post or other watercraft crashing into accessory body 19 or 20 will be diffused through accessory body 19 or 20 reducing or preventing damage to boat 1.

The particular shape of accessory bodies 19 and 20 when used together to generally surround bow 10 provides increased flotation and fender protection at the bow 10. As the bow 10 moves though water the shape of accessory bodies 19 and 20 creates beneficial lift of bow 10 as accessory bodies 19 and 20 strike water. Further the high position of accessory bodies 19 and 20, and the shape of outer faces 36 and 44 reduces water into the boat by directing splash and spray away from the boat 1 and acts as a barrier to prevent other splash and spray that might otherwise enter the boat 1.

The illustrated embodiment has the attributes of flotation, acting as a fender, providing lift and reducing splash and spray, however it is envisaged that alternative embodiments may have only 1, 2 or 3 of these attributes rather than all 4.

It will be apparent to a person skilled in the art that changes may be made to the embodiment disclosed herein without departing from the spirit and scope of the invention in its various aspects.

1. An accessory for a watercraft, the watercraft including a body including a bow having an end, a stern, and two sides, extending between the end of the bow and the stern, and including gunwales at an upper edge, and the accessory including
a body means, adapted to lie substantially along at least part of the length of one side, substantially proximal to the gunwales, and
an attachment means for attaching the body means to the watercraft,
wherein, in use, two accessories are used, attached to the watercraft by the attachment means so that a body means lies substantially along at least part of the length of each side of the watercraft and the body means are configured so as to provide increased flotation of the watercraft, in the water.

2. The accessory of claim 1, wherein if the watercraft is tilted over to one side in the water, the body means attached to the tilted side contacts water, and the body means has sufficient flotation to substantially act against the tilting.

3. The accessory of claim 1, wherein the body means also acts as a fender, substantially preventing contact between the watercraft and objects, structures or other watercraft which otherwise would contact the watercraft at or near where the accessory is attached.

4. The accessory of claim 1, wherein, the body means are also configured so as to substantially increase the lift of the watercraft as the watercraft moves through water.

5. The accessory of claim 4, wherein, in use, as the watercraft moves through water the configuration of the body means substantially increases the lift of the bow of the watercraft.

6. The accessory of claim 1, wherein, the body means are configured so as to also substantially reduce splash or spray of water in to the watercraft as the watercraft moves through water.

7. The accessory of claim 6, wherein the body means is shaped to direct splash or spray of water away from the watercraft as the watercraft moves through water.

8. The accessory of any claim 4 or 6, wherein, in use, the body means also acts as a fender, substantially preventing contact between the watercraft and objects, structures or other watercraft which otherwise would contact the watercraft at or near where the accessory is attached.

9. The accessory of any one of claim 6, wherein the body means is configured so as to substantially increase the lift of the watercraft as the watercraft moves through water.

10. The accessory of claim 1, wherein the body means also acts as a fender, substantially preventing contact between the watercraft and objects, structures or other watercraft which otherwise would contact the watercraft at or near where the accessory is attached, the body means is also configured so as to substantially increase the lift of the watercraft as the watercraft moves through water, and the body means is configured so as to substantially reduce splash or spray of water in to the watercraft as the watercraft moves through water.

11. The accessory of any one of claims 1, wherein the watercraft is a boat, tinnie or other small watercraft, used as a tender.

12. The accessory of claim 1, wherein the body means is attached somewhere between the chine line and the upper edge of the gunwales.

13. The accessory of claim 1, wherein the body means is attached high up on the side of the watercraft, close under the gunwales.

14. The accessory of claim 1, wherein the body means is made of a suitable foam material.

15. The accessory of claim 1, wherein the body means is constructed of a plurality of layers of material attached or held together.

16. The accessory of claim 1, wherein the body means is constructed of a plurality of separate parts attached by the attachment means along a side of the watercraft.

17. The accessory of claim 1, wherein an outer face of the body means has a substantially flat surface and the substantially flat surface assists to diffuse the force of an impact by objects, structures or other watercraft on the body means.

18. The accessory of claim 17, wherein the outer face and or an end face close to the end of the bow of the body means is configured to be at an angle to the vertical suitable to substantially increase lift of the watercraft as the outer face and or the end face close to the end of the bow strikes water, as the watercraft moves through water.

19. The accessory of claim 1, wherein the body means in cross-section is substantially a parallelogram.

20. The accessory of claim 1, wherein a single accessory is used and is adapted to lie substantially along at least part of the length of each side of the watercraft.

21. The accessory of any claim 1, wherein the attachment means are chosen from the group including: gluing the body means to the side of the watercraft to which the body means is to be attached by application of a suitable adhesive to the body means and or the side of the watercraft; or use of a plurality of fixing means corresponding to attachment points on the watercraft where the fixing means include any one or more of nuts and bolts, clamps, nails, pins, screws and ties, or any other suitable fixing means or any combination thereof.

22. The accessory of claim 1, wherein the body means includes one or more recess means open to an outer face of the body means, the or each recess means being adapted to receive at least part of a fixing means therethrough during attachment, and the recess means being configured so that once the body means is attached on a side of the watercraft the fixing means does not substantially project beyond the outer face of the body means.

23. The accessory of claim 22, wherein the attachment means includes one or more plate means, adapted to lie on an outer face of the body means.

24. The accessory of claim 1, wherein the body means includes one or more recess means and the attachment means includes one or more plate means, corresponding to the recess means, and the plate means are adapted to be positioned one in the or each recess means, and the fixing means is passed through both the recess means and the plate means to attach the body means to the watercraft.

25. The accessory of claim 1, wherein the body means is manufactured integral to the watercraft.

26. An accessory for a watercraft, the watercraft including a body including a bow having an end, a stern, and two sides, extending between the end of the bow and the stern, and including gunwales at an upper edge, and the accessory including
a body means, adapted to lie substantially along at least part of the length of one side, substantially proximal to the gunwales, and
an attachment means for attaching the body means to the watercraft,
wherein, in use, two accessories are used, attached to the watercraft by the attachment means so that a body means lies substantially along at least part of the length of each side of the watercraft, and the body means are also configured so as to substantially increase the lift of the watercraft as the watercraft moves through water.

27. The accessory of claim 26, wherein the body means is also shaped to direct splash or spray of water away from the watercraft as the watercraft moves through water.

28. The accessory of claim 26 or 27, wherein, in use, the body means also acts as a fender, substantially preventing contact between the watercraft and objects, structures or other watercraft which otherwise would contact the watercraft at or near where the accessory is attached.

29. A method of installing an accessory on a watercraft, the watercraft including a body including a bow having an end, a stern and two sides extending between the end of the bow and the stern, and including gunwales at an upper edge, the method including the following steps:
i) cutting a body means from a piece of suitable material to fit substantially along at least part of the length of one side of the watercraft, substantially proximal to the gunwales;
ii) shaping the body means so as to be able to lie substantially flush with the side of the watercraft and to be substantially a parallelogram shape in cross-section;
iii) attaching the body means to the side of the watercraft by attachment means;
iv) marking and making one or more recesses means in the body means for receipt of the attachment means therethrough; and
v) positioning plate means in the or each recess means before attaching the body means to the watercraft.

30. The method of claim 29, wherein the accessory is the accessory of claim 1.
